(19) United States
(12) Patent Application Publication
(10) Pub. No.: US 2008/0025599 A1
(43) Pub. Date: Jan. 31, 2008

(54) Apparatus and method for providing colorimetric information

(75) Inventors: Sung-Dae Cho, Yongin-si (KR); Sang-Wook Oh, Ansan-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/880,668

(22) Filed: Jul. 24, 2007

(30) Foreign Application Priority Data
Jul. 24, 2006 (KR) 2006-69266

(51) Int. Cl. G01J 3/10; G06K 9/00; H04N 5/225

(52) U.S. Cl. 382/162

(57) ABSTRACT

An apparatus and method for providing calorimetric information are provided. A camera photographs an image including a desired calorimetric portion. A controller computes a mean color value of the desired colorimetric portion from the photographed image and retrieves a colorimetric value mapped to the computed mean color value from a pre-stored color table. If the colorimetric value mapped to the computed mean color value is retrieved from the pre-stored color table, a display receives the retrieved calorimetric value from the controller and outputs the colorimetric value as colorimetric information of the desired calorimetric portion.

### CLAIM OF PRIORITY

This application claims the benefit under 35 U.S.C. § 119(a) of a Korean Patent Application filed in the Korean Intellectual Property Office on Jul. 24, 2006 and assigned Serial No. 2006-69266, the entire disclosure of which is hereby incorporated by reference.

### BACKGROUND OF THE INVENTION

1. Field of the Invention

The present invention generally relates to a calorimetric information provider, and more particularly to an apparatus and method for providing colorimetric information relating to external color characteristics using an input signal acquired through an imaging device.

2. Description of the Related Art

Colorimetry is used to physically measure colors and converting the measured colors into numerical values. A Munsell colorimetric system is known for expressing hue, lightness, and chroma. An XYZ colorimetric system is known for expressing and mapping X, Y and Z values to three primary colors, and the like. It is important to specify an objective color value and perform color management in the colorimetry. For objective color measurement, international measurement standards and criteria for color representation are provided.

Recently, the importance of colorimetry is growing in a variety of fields, such as cloth selection, interior decoration, light installation, and the like, as well as electronic products including a monitor, television, printer, and the like. Moreover, the importance of photometric and colorimetric equipments for implementing high-quality products is increasing.

There are many calorimetric methods. A colorimeter is mandatory for providing an exact measurement. The calorimeter can reduce many deviation factors occurring when colors are measured in a typical human eye. Typically, calorimetric systems are classified into a filter-type calorimetric system for directly measuring tristimulus values X, Y and Z using three sensors having the same spectral sensitivity as the typical human visual system, and a spectral-type colorimetric system for measuring a visual-ray spectral reflectance factor of a sample and producing tristimulus values or chromatic coordinates using the spectral reflectance factor of the sample, a Commission Internationale de l'Eclairage (CIE) standard light source, and a CIE standard observer.

However, the conventional colorimeter may not be portable and its power connection may be inconvenient in real implementation. Moreover, it is not economical to widely use the colorimeter due to its high cost.

### SUMMARY OF THE INVENTION

An aspect of exemplary embodiments of the present invention is to address at least the above problems and/or disadvantages and to provide additional advantages described below.

Accordingly, an aspect of exemplary embodiments of the present invention is to provide an apparatus and method that can allow a user to easily perform a calorimetric process in an environment, by providing colorimetric information relating to external color characteristics using an input signal acquired through a camera of an imaging device.

In accordance with an aspect of exemplary embodiments of the present invention, there is provided an apparatus for providing colorimetric information which includes: a camera for photographing an image having a desired calorimetric portion; a controller for computing a mean color value of the desired colorimetric portion from the photographed image and retrieving a calorimetric value mapped to the computed mean color value from a pre-stored color table; and a display for receiving the retrieved colorimetric value from the controller if the colorimetric value mapped to the computed mean color value is retrieved from the pre-stored color table and outputting the colorimetric value as colorimetric information of the desired calorimetric portion.

Preferably, the apparatus may further include a memory for storing the color table.

### BRIEF DESCRIPTION OF THE DRAWINGS

The above and other features and advantages of the present invention will be more apparent from the following detailed description taken in conjunction with the accompanying drawings, in which:

FIG. 1 is a block diagram illustrating a mobile communication terminal in accordance with an exemplary embodiment of the present invention;

FIG. 2 illustrates an example of a configuration for generating a color table in accordance with an exemplary embodiment of the present invention;

FIG. 3 is a flowchart illustrating a process for providing calorimetric information in the mobile communication terminal in accordance with an exemplary embodiment of the present invention; and

FIGS. 4A and 4B illustrate examples of images for providing calorimetric information in the mobile communication terminal in accordance with an exemplary embodiment of the present invention.

### DETAILED DESCRIPTION OF EXEMPLARY EMBODIMENTS

Exemplary embodiments of the present invention will be described in detail herein below with reference to the accompanying drawings. Descriptions of well-known functions and constructions are omitted for clarity and conciseness and to avoid redundancy.

In accordance with an exemplary embodiment of the present invention, for example, a calorimetric information provider applied to a mobile communication terminal among imaging devices will be described. The imaging devices may include a digital camera, a personal digital assistant (PDA), a smart phone, a portable multimedia player (PMP), and a mobile communication terminal equipped with a camera or any imaging devices.

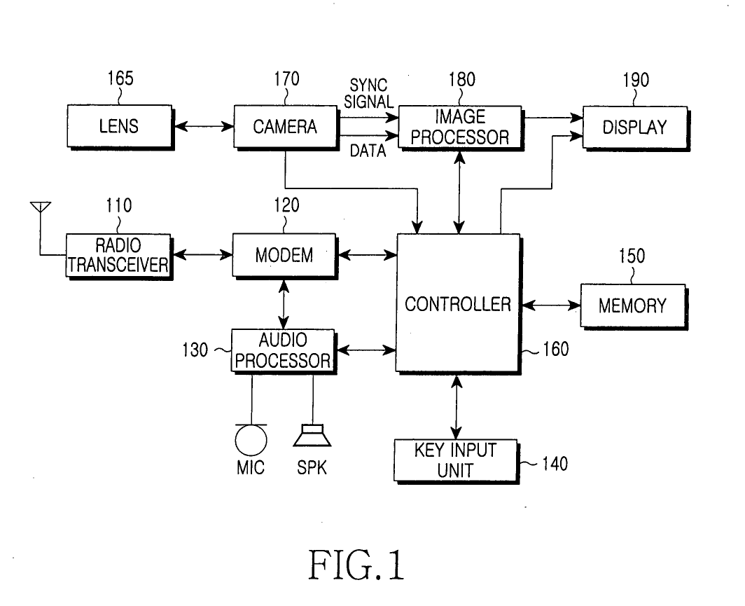

FIG. 1 is a block diagram illustrating a mobile communication terminal in accordance with an exemplary embodiment of the present invention.

Referring to FIG. 1, the mobile communication terminal in accordance with the exemplary embodiment of the present invention may be provided with a radio transceiver 110, a modulator-demodulator (modem) 120, an audio processor 130, a key input unit 140, a memory 150, a controller 160, a lens section 165, a camera 170, an image processor 180, and a display 190.

In operation, the radio transceiver 110 is responsible for transmitting and receiving voice, text, image, and control data under control of the controller 160. To this end, the radio transceiver 110 can be provided with a radio frequency (RF) transmitter for up converting and amplifying a frequency of a signal to be transmitted, and an RF receiver for low-noise amplifying a received signal and down converting a frequency of the received signal.

The modem 120 can be provided with a transmitter for encoding and modulating the signal to be transmitted through the radio transceiver 110, and a receiver for demodulating and decoding the received signal.

The audio processor 130 can be provided with a coder-decoder (codec). The codec is provided with a data codec for processing packet data and an audio codec for processing an audio signal, such as voice and the like. The audio processor 130 modulates an electric signal input from a microphone and converts the modulated signal into voice data. The audio processor 130 demodulates encoded voice data input from the radio transceiver 110 into an electric signal, then outputs the electric signal to a speaker. Preferably, the audio processor 130 may be provided with a codec for converting a digital audio signal received from the radio transceiver 110 into an analog audio signal in order to reproduce the analog audio signal, or converting an analog audio signal generated from the microphone into a digital audio signal. The codec may be provided in the controller 160.

The key input unit 140 is provided with a key matrix structure (not illustrated), and is provided with alphanumeric keys, function keys, and external volume keys. The key input unit 140 provides the controller 160 with a key input signal mapped to a key input by a user. The key input unit 140 can be provided with camera keys and a calorimetric information key for providing colorimetric information. The camera keys can be provided with a camera power key to be used in camera mode, a zoom key for controlling the zoom of a camera lens, and a shutter key for photographing an image.

The memory 150 may be constructed with a program memory and a data memory, and stores information selected on the basis of user selection information and information required to control the operation of the mobile communication terminal. When calorimetric information is provided, the memory 150 can store programs for controlling the camera 170 and the lens section 165 having a camera lens during the camera mode (that is, photography mode).

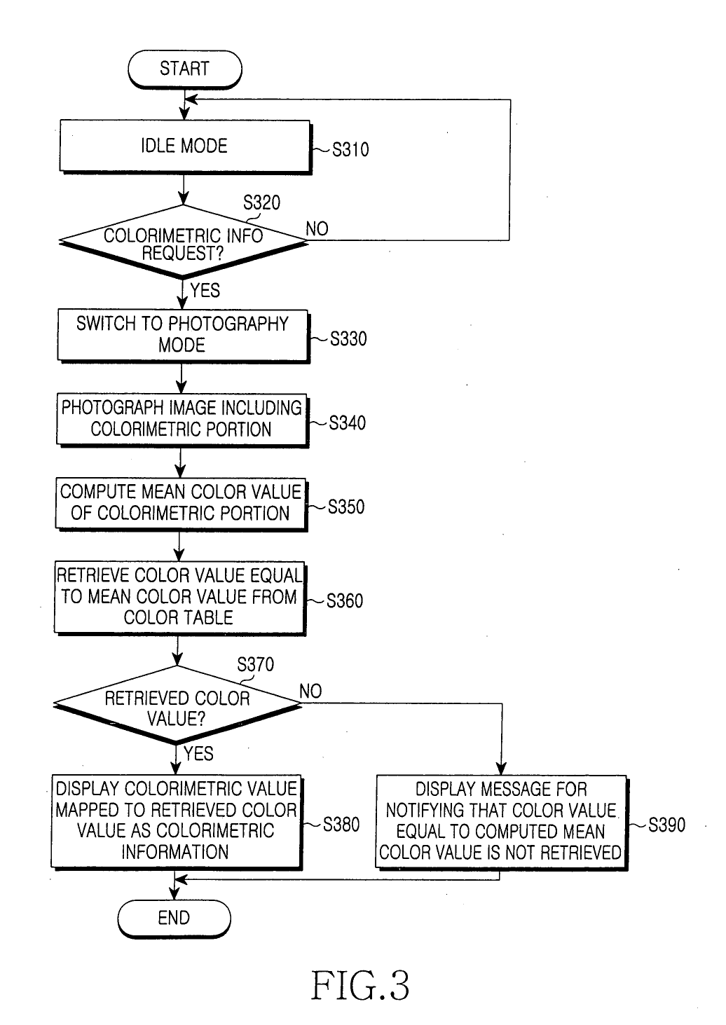

The memory 150 stores a color table for providing the colorimetric information. The color table stores color values computed by photographing colors of a color chart through the camera 170 and calorimetric values computed by measuring the colors of the color chart through a colorimeter in one-to-one correspondence on a color-by-color basis. Herein, the colors of the color chart may be arbitrarily selected by the user, or may be provided during the manufacturing stage of the mobile communication terminal. This color table will be described in detail with reference to FIG. 3.

The controller 160 controls overall operations of the mobile communication terminal. In particular, the controller 160 controls the color table to store the color values and the calorimetric values mentioned-above.

When a calorimetric information request signal is input from the key input unit 140, the controller 160 switches the mobile communication terminal to the photography mode for providing the colorimetric information. When the user inputs the shutter key for photographing an image including a desired colorimetric portion, the controller 160 controls the operation for computing a mean color value of the desired colorimetric portion. At this time, the controller 160 controls the display 190 to display the colorimetric portion capable of being perceived by the user. Herein, the mean color value of the desired calorimetric portion can be acquired by computing a mean value of each color of red, green and blue (RGB) from the colorimetric portion. Since a method for computing the mean color value of the calorimetric portion is well known to those skilled in this art, its detailed description is omitted.

When the mean color value of the desired calorimetric portion is computed from the photographed image, the controller 160 retrieves a color value equal to the computed mean color value from a pre-stored color table. When the color value equal to the computed mean color value is retrieved from the color table, the controller 160 controls the display 190 to display a colorimetric value mapped to the color value retrieved from the color table as calorimetric information.

The camera 170 is provided with the lens section 165 having a zooming feature to capture an image. The camera 170 is provided with a camera sensor (not illustrated) for converting photographed optical signals into electrical signals and a signal processor (not illustrated) for converting analog signals photographed by the camera sensor into digital data. Herein, the camera sensor may be, for example, a charge coupled device (CCD) sensor, and the signal processor may be, for example, implemented with a digital signal processor (DSP). In alternate embodiment, the camera sensor and the signal processor can be integrated or stand-alone

The camera 170 photographs an image including a desired colorimetric portion under control of the controller 160. The camera 170 is switched to the photography mode for providing the colorimetric information by the controller 160. When the image including the desired colorimetric portion is photographed, the signal processor converts the photographed image into digital data and then provides the controller 160 with the digital data.

The image processor 180 generates screen data for displaying image signals output from the camera 170. In general photography mode rather than the photography mode for providing the calorimetric information, the image processor 180 processes the image signals output from the camera 170 frame by frame, and matches frame video data to the characteristic and size of the display 190.

The image processor 180 is provided with an image codec, and compresses the frame video data displayed on the display 190 in a predefined scheme or decompresses compressed frame video data to the original frame video data. It is assumed that the image processor 180 is provided with an on-screen display (OSD) function and can output OSD data according to the size of a displayed screen under the control of the controller 160.

The display 190 may be a liquid crystal display (LCD), and outputs various display data generated in the mobile communication terminal. When the LCD is implemented with a touch screen, the display 190 may also serve as an input unit. The display 190 displays video signals output from the image processor 180 on a screen and displays user data output from the controller 160.

The display 190 displays a calorimetric value retrieved from the color table as colorimetric information of a desired calorimetric portion under the control of the controller 160. The user can detect the calorimetric value of the calorimetric portion from the calorimetric information displayed on the display 190.

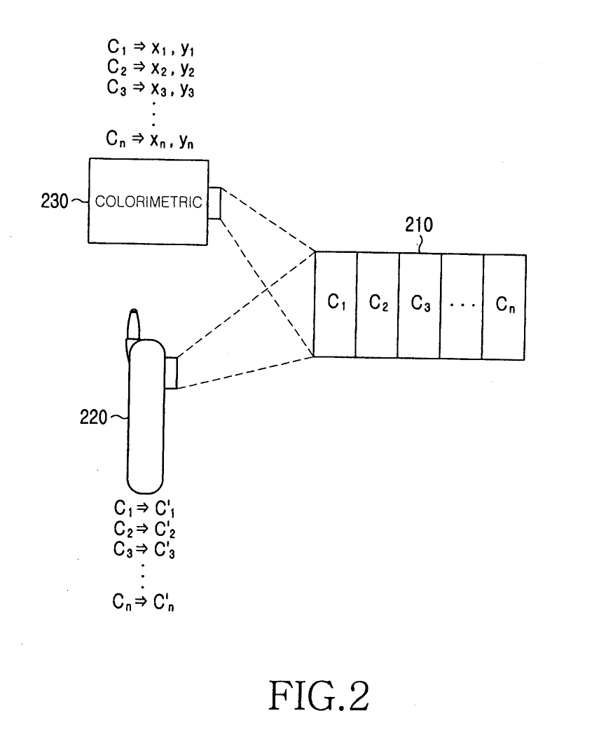

FIG. 2 illustrates an example of a configuration for generating a color table in accordance with an exemplary embodiment of the present invention. As shown, the configuration for generating a color table is provided with a color chart 210, a mobile communication terminal 220, and a colorimeter 230.

The color chart 210 is constructed with predetermined colors. The predetermined colors in the color chart 210 may be arbitrarily selected by a user, or may be provided by manufacturer of the mobile communication terminal.

In the exemplary embodiment of the present invention, the mobile communication terminal 220 and the colorimeter 230 generate the color table by measuring and photographing colors of the color chart 210, computing a colorimetric value and a color value, and storing the computed values in one-to-one correspondence on a color-by-color basis.

First, the mobile communication terminal 220 photographs colors of the color chart 210 using its camera and computes color values on the basis of the colors in the color chart 210.

The calorimeter 230 is a general colorimeter for illuminating light of a Xenon lamp serving as a light source on a color sample, collecting reflected light in an integrating sphere, specifying a signal in a numerical value, and displaying a unique reflectance value of the associated color sample. In the colorimeter, colorimetric systems are classified into a filter-type calorimetric system for directly measuring tristimulus values X, Y and Z using three sensors having the same spectral sensitivity as a typical human visual system, and a spectral-type colorimetric system for measuring a visual-ray spectral reflectance factor of a sample and producing tristimulus values or chromatic coordinates using the spectral reflectance factor of the sample, a Commission Internationale de l'Eclairage (CIE) standard light source, and a CIE standard observer. Hence, the colorimeter 230 measures colors of the color chart 210 and computes calorimetric values.

Color values and colorimetric values computed using the color chart 210, the mobile communication terminal 220 equipped with the camera, and the colorimeter 230 are stored as shown in Table 1.

TABLE 1

| Color values | Colorimetric values |
|---|---|
| C′₁ | x₁, y₁ |
| C′₂ | x₂, y₂ |
| C′₃ | x₃, y₃ |

Referring to Table 1, the color values are mapped to colors C₁, C₂, C₃, . . . , Cₙ of the color chart 210. These color values can be computed by analyzing RGB color combinations of an image photographed by the camera of the mobile communication terminal 220.

An RGB color combination is constructed with three colors of red, green, and blue. Each color is expressed by numbers of 0˜255. The user makes a desired color using a combination of numbers. For example, (255, 0, 0) indicates red. In accordance with an exemplary embodiment of the present invention, colors of the color chart 210 are photographed with the camera provided in the mobile communication terminal 220. Thus, color values are computed by analyzing an RGB color combination of a photographed image. If a result obtained by analyzing the RGB color combination of the photographed image is (255, 0, 0), the color value of red is C′₁. If the analysis result is (0, 255, 0), the color value of green is C′₂.

The calorimetric values indicate the colors of the color chart 210. Values measured by the colorimeter 230 are XYZ tristimulus values. These XYZ tristimulus values indicate a color based on a ratio of mixture amounts of red, green, and blue corresponding to the three primary colors. Colors are objectively expressed in numerical values by defining color matching functions of the CIE standard observer. Herein, Y indicates a brightness value, and X and Z indicate color values. In an exemplary embodiment of the present invention, the color values are expressed only by two values x and y. As shown in Table 1, a color value mapped to C₁ of red is expressed by x₁ and y₁. Since the XYZ tristimulus values are well known to those skilled in this art, it detailed description is omitted.

In accordance with an exemplary embodiment of the present invention, the color table is generated by storing computed colorimetric values and color values of the color chart 210 in one-to-one correspondence on a color-by-color basis using the color chart 210, the mobile communication terminal 220 with the camera, and the colorimeter 230.

FIG. 3 is a flowchart illustrating a process for providing calorimetric information in a mobile communication terminal in accordance with an exemplary embodiment of the present invention.

Referring to FIG. 3, the controller 160 is in idle mode (step S310). When a calorimetric information request signal is input from the key input unit 140 (step S320), the controller 160 controls the camera 170 to be switched to a photography mode in which colorimetric information is provided (step S330). When the user inputs the shutter key for photographing an image having a desired colorimetric portion, the camera 170 photographs the image including the calorimetric portion, converts the photographed image into digital data, and provides the controller 160 with the digital data (step S340). At this time, the controller 160 can control the display 190 to display the calorimetric portion capable of being perceived by the user.

When the image photographed by the camera 170 is input, the controller 160 computes a mean color value of the colorimetric portion (step S350). Herein, the mean color value of the calorimetric portion is computed from the mean values of RGB colors of the colorimetric portion. Since a method for computing the mean color value is well known to those skilled in this art, its detailed description is omitted.

When the mean color value of the colorimetric portion is computed from the photographed image, the controller 160 retrieves a color value equal to the computed mean color value from the color table pre-stored in the memory 150 (step S360).

If the color value equal to the computed mean color value is retrieved from the color table, the display 190 displays a calorimetric value mapped to the color value retrieved from the color table as colorimetric information (step S370).

However, if the color value equal to the computed mean color value is not retrieved from the color table, a message for notifying that colorimetric information of a desired calorimetric portion is not designated is displayed (step S380).

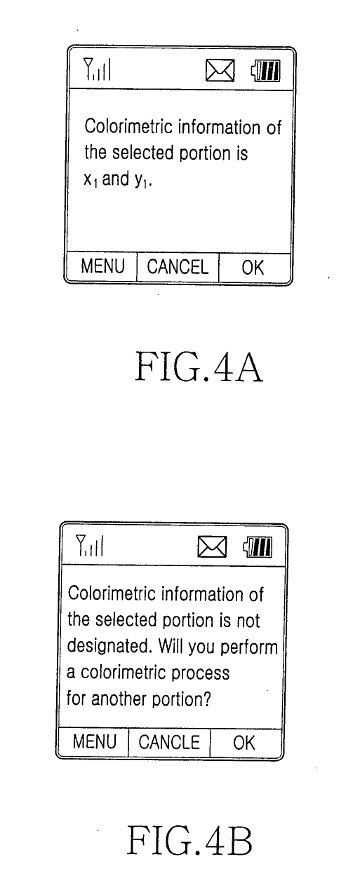

FIGS. 4A and 4B illustrate examples of images for providing colorimetric information in the mobile communication terminal in accordance with an exemplary embodiment of the present invention.

FIG. 4A illustrates an example of an image for providing a colorimetric value mapped to a retrieved color value as calorimetric information of a desired colorimetric portion by retrieving the color value equal to a mean color value computed from the calorimetric portion of the image photographed by the camera.

If the mean color value computed from the desired calorimetric portion is (255, 0, 0) as the red C₁, the value corresponds to C′₁ in the color table. Thus, x₁ and y₁ mapped to C′₁ of the color table are a calorimetric value of the desired calorimetric portion. If the calorimetric value of the desired colorimetric portion is retrieved, a message of “Colorimetric information of the selected portion is x₁ and y₁.” is displayed as illustrated in FIG. 4A.

However, if the color value equal to the mean color value computed from the desired calorimetric portion is not retrieved from the color table, a message of “Colorimetric information of the selected portion is not designated. Will you perform a calorimetric process for another portion?” is displayed as illustrated in FIG. 4B. The message notifies the user that a calorimetric value of the desired colorimetric portion is not designated. Thus, the user can update a colorimetric value of the color table by updating a color type of the color table through a mobile communication network or directly performing a colorimetric process with the calorimeter.

When calorimetric information of a desired colorimetric portion is provided using an input signal of an image acquired through the camera provided in the mobile communication terminal, a user can easily and selectively perform a calorimetric process for an environment.

As is apparent from the above description, the present invention can allow a user to conveniently and easily perform a colorimetric process for an environment by providing calorimetric information regarding external color characteristics using an input signal acquired through a camera of an imaging device.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. An apparatus for providing colorimetric information, comprising:
a camera configured to capture an image indicative of a desired calorimetric portion;
a controller configured to compute a mean color value corresponding to the desired calorimetric portion and retrieving a calorimetric value mapped to the computed mean color value from a pre-stored color table; and
a display configured to receive the retrieved calorimetric value from the controller and outputting the colorimetric value as calorimetric information indicative of the desired colorimetric portion.

2. The apparatus of claim 1, wherein the color table stores values of colors of a color chart captured by the camera and colorimetric values of the colors of the color chart measured by a colorimeter in one-to-one correspondence on a color-by-color basis.

3. The apparatus of claim 2, wherein the colors of the color chart comprise colors arbitrarily selected by a user or provided by a manufacturer of a mobile communication terminal.

4. The apparatus of claim 1, wherein the mean color value is a mean value computed for colors of red, green and blue (RGB) from the desired colorimetric portion of the image captured by the camera.

5. The apparatus of claim 1, further comprising:
a memory for storing the color table.

6. A method for providing calorimetric information, comprising:
photographing an image comprising a desired colorimetric portion using a camera;
computing a mean color value of the desired colorimetric portion from the photographed image;
retrieving a colorimetric value mapped to the computed mean color value from a color table; and
providing the calorimetric value as colorimetric information of the desired colorimetric portion if the calorimetric value mapped to the computed mean color value is retrieved from the color table.

7. The method of claim 6, further comprising:
notifying that a calorimetric value of the desired colorimetric portion is not stored if the colorimetric value mapped to the computed mean color value is not retrieved from the color table.

8. The method of claim 6, wherein the color table stores values of colors of a color chart photographed by the camera and calorimetric values of the colors of the color chart measured by a calorimeter in one-to-one correspondence on a color-by-color basis.

9. The method of claim 8, wherein the colors of the color chart comprise colors arbitrarily selected by a user or provided by a manufacturer of a mobile communication terminal.

10. The method of claim 6, wherein the mean color value is a mean value computed for colors of red, green and blue (RGB) from the desired calorimetric portion of the image photographed by the camera.

11. An image processing system for providing calorimetric information, comprising:
an image capturing means which captures an image;
means for computing color value of the captured image indicative of a desired colorimetric portion and retrieving, from a predetermined color table, a colorimetric value corresponding to the computed mean color value; and
a display means which displays the retrieved colorimetric value representing the desired calorimetric portion.

12. The system of claim 1, wherein the predetermined color table stores values of colors of a color chart captured by the imaging capturing means and colorimetric values of the colors of the color chart measured by a colorimeter.

13. The system of claim 12, wherein the colors of the color chart comprise colors selected by a user or provided by a manufacturer of a mobile communication terminal.

14. The system of claim 11, wherein the mean color value is a mean value computed for colors of red, green and blue (RGB) from the desired calorimetric portion.

15. The system of claim 11, further comprising:
a memory for storing the color table.
